(19) United States
(12) Patent Application Publication
(10) Pub. No.: US 2008/0308081 A1
(43) Pub. Date: Dec. 18, 2008

(54) Disposable gas system for internal combustion engine

(76) Inventor: Ernest George Geros, Albuquerque, NM (US)

Correspondence Address: Medrano & Hogans, P.A., P.O. Box 66025, Albuquerque, NM, 87193, US

(21) Appl. No.: 11/820,113

(22) Filed: Jun. 18, 2007

(51) Int. Cl. F02M 21/02

(52) U.S. Cl. 123/585

(57) ABSTRACT

A disposable gas system that includes: a reservoir including an opening and an orifice; a disposable gas container connected to the reservoir through the opening; and the orifice connected to an internal combustion engine.

### TECHNICAL FIELD

The present invention relates generally to a disposable gas system, and more particularly to a disposable gas system for an internal combustion engine.

### BACKGROUND ART

The internal combustion engine is a machine that converts the ignition of a fuel and air mixture within a confined space (e.g.—a cylinder) into mechanical energy. Generally, the mechanical energy produced by the ignition of the fuel/air mixture is manifested by the movement of a piston within the cylinder, whose movement is commonly translated into a rotational force that produces motion. The power produced by the internal combustion engine is commonly measured in terms of horserpower and internal combustion engine enthusiasts are always trying to maximize the amount of horserpower produced by their internal combustion engines.

In this regard, nitrous oxide (N₂O) or nitrous has become a staple of internal combustion engine enthusiasts for improving the horsepower of their engines. It turns out that when nitrous oxide is introduced into an internal combustion engine that the intense heat within the internal combustion engine cylinder breaks down the nitrous oxide (at about 570° F.) into its constituent components of nitrogen and oxygen. Consequently, the injection of nitrous oxide into an engine means that more oxygen is available during combustion, thereby allowing the same engine to produce more power when more fuel is added. Additionally, nitrous oxide provides a significant cooling effect on the intake air when it vaporizes, thereby increasing the intake air's density, and consequently providing even more oxygen inside the internal combustion engine cylinder. Combining the preceding with the fact that nitrous oxide is 50% more dense than atmospheric air to begin with, it becomes readily apparent why nitrous has become one of the simplest ways to provide a significant horsepower boost to any gasoline powered engine.

Unfortunately, one of the major drawbacks of a nitrous oxide system is that the contents (i.e.—the nitrous oxide) of the nitrous oxide system are used up very quickly; therefore, supplying only a limited amount of increased performance. To put this in perspective, a 5-liter car engine running at 4,000 revolutions per minute (rpm) consumes about 10,000 liters of air every minute, so it would take a tremendous quantity of nitrous oxide to run the car continuously. Therefore, the user of a nitrous oxide system is frequently required to locate and drive to a gas supply retailer to recharge their empty nitrous oxide containers, which takes considerable time, especially for a user located in a remote region.

Thus, a need still remains for a disposable gas system that does not require the user of such system to locate and drive to a gas supply retailer to recharge their empty gas containers.

### DISCLOSURE OF THE INVENTION

The present invention provides a disposable gas system including: a reservoir including an opening and an orifice; a disposable gas container connected to the reservoir through the opening; and the orifice connected to an internal combustion engine.

Additional features and aspects of the invention will become apparent to those skilled in the art from a reading of the detailed description, taken in conjunction with and reference to the accompanying drawings.

### BRIEF DESCRIPTION OF THE DRAWINGS

FIG. 1 is a cross sectional view of a disposable gas system, in accordance with an embodiment of the present invention;

FIG. 2 is a perspective view of a disposable gas system, in accordance with an embodiment of the present invention;

FIG. 3 is a top view of a disposable gas system with a cap, of FIG. 1, removed, in accordance with an embodiment of the present invention;

FIG. 4 is a cross sectional view of a disposable gas system, in accordance with another embodiment of the present invention;

FIG. 5 is a perspective view of a disposable gas system, in accordance with another embodiment of the present invention;

FIG. 6 is a top view of a disposable gas system with a cap, of FIG. 4, removed, in accordance with another embodiment of the present invention;

FIG. 7 is a side view of a disposable gas system, in accordance with another embodiment of the present invention;

FIG. 8 is a side view of a disposable gas system, in accordance with another embodiment of the present invention;

FIG. 9 is a top view of a disposable gas system with a disposable gas container, of FIG. 8, removed, in accordance with an embodiment of the present invention:

FIG. 10 is a generalized block diagram of how a disposable gas system interfaces with an internal combustion engine, in accordance with an embodiment of the present invention.

### BEST MODE FOR CARRYING OUT THE INVENTION

Reference will now be made to the exemplary embodiments illustrated in the drawings, and specific language will be used herein to describe the same. These embodiments are described with sufficient detail to enable those skilled in the art to practice the invention. However, it is to be understood that other embodiments may be employed and that many modifications, additions, and/or omissions may be made to the process or structure described herein without departing from the scope of the present invention. Accordingly, the present invention is not limited by the description of the exemplary embodiments.

For purposes of clarity and comprehension thereof similar features between different embodiments will ordinarily be described with like reference numerals.

The terms “example” or “exemplary” are used herein to mean serving as an instance or illustration. Any aspect or embodiment described herein as an “example” or as “exemplary” is not necessarily to be construed as preferred or advantageous over other aspects or designs.

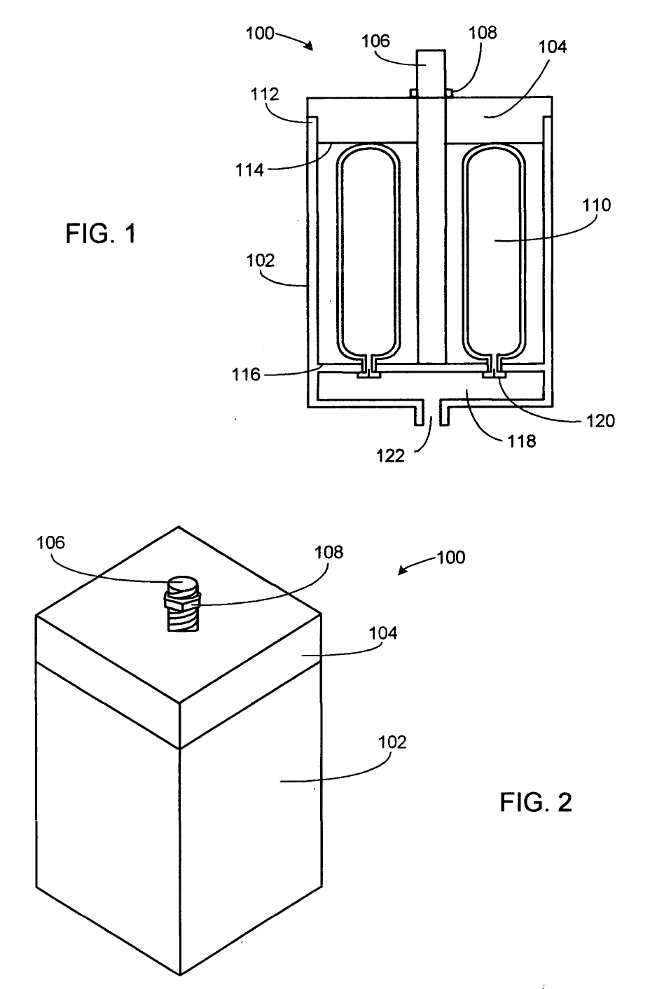

Referring now to FIG. 1, therein is shown a cross sectional view of a disposable gas system 100, in accordance with an embodiment of the present invention. The disposable gas system 100 includes a housing 102, a cap 104, a bolt 106, a nut 108, a disposable gas container 110, a housing first end 112, a cap bottom side 114, a housing second end 116, a gas supply system 118, a spike 120, and an orifice 122. Generally, the disposable gas system 100 can be used for enhancing the performance of an internal combustion engine. More specifically, the disposable gas system 100 may dispense a gas, such as nitrous oxide, within an internal combustion engine of a car, boat, motorcycle, airplane, or other like mode of transportation employing an internal combustion engine.

Per this embodiment, the housing 102 includes a configuration possessing one or more rectangular or square shaped walls connected together to form a structure capable of holding objects within its volume. By way of example, the housing 102 may include a square-shaped or rectangular-shaped box. However, it is to be understood that the shape of the housing 102 is not to be limited to these examples. In accordance with the scope of the present invention the shape of the housing 102 may include any rectilinear design or shape that has been structurally engineered to hold or contain one or more of the disposable gas container 110 within its volume.

The housing 102 can be designed to permit direct mounting to any structure or the housing 102 can be mounted to a specifically constructed bracket system including a resilient clasp system, which permits easy removal of the housing 102 from the bracket system.

By way of example, the housing 102 can be constructed from a material such as metal, plastic, or a combination thereof. Furthermore, it is to be understood that a heating element can be placed within the volume defined by the housing 102, thereby counteracting the reduced temperatures that may arise during discharge of the disposable gas container 110.

At the housing first end 112, the cap 104 is secured to the housing 102 by the bolt 106 and the nut 108. The cap 104 can be structurally designed to form a tight seal with the housing 102. In a preferred aspect of the present invention, the perimeter of the cap 104 inserted within the housing 102 may include a gasket for creating an airtight seal between the cap 104 and the housing 102. Alternatively, the portion of the housing 102 adjacent the cap 104 after insertion of the cap 104 within the housing 102 may include a gasket for creating an airtight seal between the cap 104 and the housing 102.

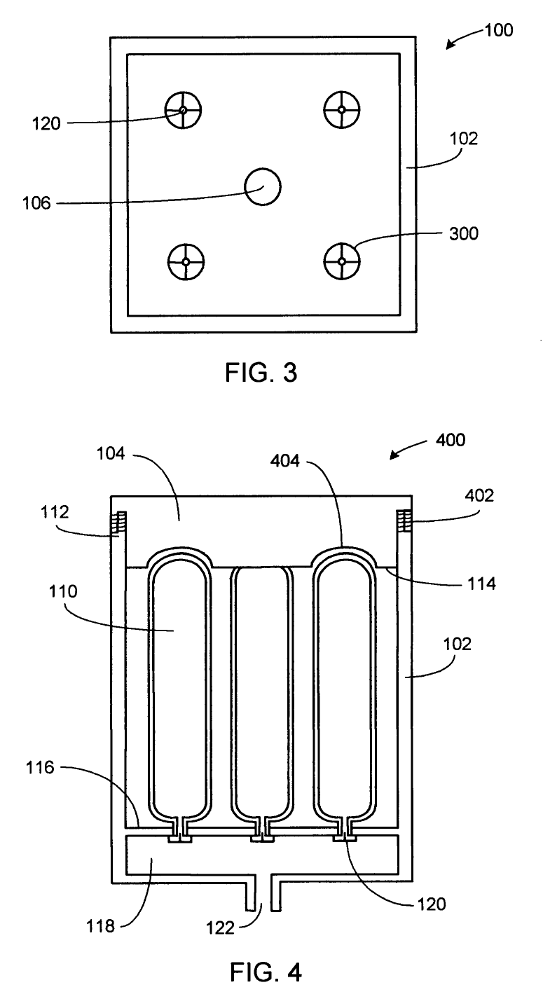

Notably, the cap bottom side 114 extends into the housing 102, thereby permitting contact with the disposable gas container 110. Each of the disposable gas container 110 are mounted, connected, and/or securely coupled to the gas supply system 118 through an opening 300, of FIG. 3, formed in the housing second end 116. Per this invention, “securely coupled” is defined to mean that the disposable gas container 110 does not break its airtight seal with the opening 300 during discharge of its contents into the gas supply system 118.

The opening 300 may include a press fit mechanism, wherein the disposable gas container 110 is held in place by the cap 104; or, the opening 300 may include a screw-in type mechanism, wherein the disposable gas container 110 is held in place by the threads on the disposable gas container 110 and within the opening 300. By way of example, the opening 300 may include a one-way valve, which permits gas to enter the gas supply system 118, and a puncture type mechanism (e.g.—the spike 120) that breaks the seal on the disposable gas container 110 when a sufficient force is applied.

However, it is to be understood that the type of structure (i.e.—the opening 300) used to release the contents of the disposable gas container 110 into the gas supply system 118 is not limited by the above example. In accordance with the scope of the present invention, the structure may include any system or mechanism that permits discharge of the contents of the disposable gas container 110 into the gas supply system 118 upon a sufficient force being applied to the seal of the disposable gas container 110. Furthermore, it is to be understood that the opening 300 may include a gasket, thereby creating an airtight seal that helps to prevent backflow of the discharged contents from the gas supply system 118 into the housing 102 or back into the disposable gas container 110.

In an aspect of the present embodiment, the cap 104 can provide a mechanism for asserting sufficient pressure or force upon the disposable gas container 110 to discharge its contents. For example, the depth of the cap 104 that extends into the housing 102 can be structurally engineered to make contact with the disposable gas container 110, thereby permitting discharge of the contents of the disposable gas container 110 when sufficient force is applied by the cap 104 upon the disposable gas container 110.

Generally, the cap 104 can be tightened against the disposable gas container 110 by tightening the nut 108 against the cap 104. More specifically, the cap bottom side 114 may exert a force upon the disposable gas container 110, located within the housing 102, when the nut 108 exerts a force upon the cap 104. Upon the nut 108 exerting a sufficient force against the cap 104, the disposable gas container 110 can be displaced towards the gas supply system 118 and the seal of the disposable gas container 110 can be broken against the spike 120. After the spike 120 breaks the seal of the disposable gas container 110, the contents of the disposable gas container 110 can be released into the gas supply system 118 through the opening 300. Additionally, the cap bottom side 114 may include depressions (not shown) that align with each of the disposable gas container 110, thereby ensuring a secure contact between the cap 104 and the disposable gas container 110.

Per this embodiment, the bolt 106, such as a threaded rod, is securely affixed to the housing second end 116 of the housing 102, which opposes the housing first end 112. The bolt 106 passes through an aperture formed within the cap 104, thereby extending a finite distance above the cap 104. By way of example, the interface between the bolt 106 and the cap 104 may also include a gasket for creating an airtight seal between the cap 104 and the bolt 106. The bolt 106 provides a permanent structure upon which the nut 108 can be tightened or loosened, thereby either allowing removal of the cap 104 or permitting the nut 108 to exert a force upon the cap 104.

Alternatively, in another aspect of the present embodiment, the disposable gas container 110 can be threaded or screwed (e.g.—including reverse threading) into the opening 300 and the contents of the disposable gas container 110 can be discharged within the gas supply system 118 upon breaking the seal of the disposable gas container 110 upon the spike 120. Per this embodiment, the cap 104 can be designed to provide a force sufficient to merely hold the disposable gas container 110 in place (e.g.—if the disposable gas container 110 is a screw in puncture type). Additionally, the cap bottom side 114 may include depressions that align with each of the disposable gas container 110, thereby ensuring a secure contact between the cap 104 and the disposable gas container 110.

The gas supply system 118 collects the discharged contents from one or more of the disposable gas container 110 and channels the discharged contents through the orifice 122. Per this embodiment, the gas supply system 118 can generally be described as a hollow structure or reservoir used for conveying or containing gas. The gas supply system 118 can be structurally engineered and designed to withstand the pressure created and/or exerted by the discharged contents of the disposable gas container 110. Moreover, the gas supply system 118 and the opening 300 are structurally engineered and designed to prevent release of its contents, except through the orifice 122.

The orifice 122 can be connected to an internal combustion engine through a conduit, such as a high-pressure hose (not shown), for example. By way of example, the conduit or hose can inject the contents of the gas supply system 118 into an air intake manifold, a cylinder head, a fuel injector, and/or a carburetor of an internal combustion engine. The methods employed and materials used for attaching/connecting a conduit (e.g.—a hose) to and between the disposable gas system 100 and an internal combustion engine are well known within the art and not repeated herein.

Uniquely, the disposable gas container 110 of the present invention is a non-refillable cylinder, cartridge, or container that can be of any size and can be replaced with another one of the disposable gas container 110 of any size. In a preferred aspect, the disposable gas container 110 may more specifically include a container that is one liter or smaller.

The present inventor has discovered that by providing the disposable gas system 100 with the disposable gas container 110 that the user of this system no longer needs to return to a gas supply retailer to recharge their empty gas containers. The user of the disposable gas system 100 is merely required to only anticipate their future need of gas and order such amount from an order distribution service. After placing an order (e.g.—by phone, internet, or mail), the requested product (i.e.—the disposable gas container 110) is shipped to the requesting party via mail, an independent delivery service, or other approved shipping method, for example.

Notably, the disposable gas container 110 may include any type of gas, which enhances the performance, output or power of an internal combustion engine. By way of example, the disposable gas container 110 may include oxygen, oxygenated liquids, kerosene, methane, ethanol, and/or a combination thereof. In a preferred aspect of the present invention, the disposable gas container 110 includes nitrous oxide.

Referring now to FIG. 2, therein is shown a perspective view of the disposable gas system 100, in accordance with an embodiment of the present invention. This view depicts the housing 102, the cap 104, the bolt 106, and the nut 108. Although this illustration depicts the disposable gas system 100 as a rectangular shaped container, it is to be understood that the configuration of the disposable gas system 100 may include any rectilinear design or shape that has been structurally engineered to hold or contain one or more of the disposable gas container 110, of FIG. 1, within its volume.

Referring now to FIG. 3, therein is shown a top view of the disposable gas system 100 with the cap 104, of FIG. 1, removed, in accordance with an embodiment of the present invention. This view depicts the housing 102, the bolt 106, the spike 120 and the opening 300. Per this embodiment, the opening 300 can be structurally engineered to accommodate the insertion of the disposable gas container 110, of FIG. 1. By way of example, the opening 300 can be designed as a screw-in insertion type mechanism or the opening 300 can be designed to securely hold the disposable gas container 110 in place while the cap 104 is tightened against the disposable gas container 110. Stated another way, the opening 300 may include a press fit mechanism (sufficiently tight to hold the disposable gas container 110), wherein the disposable gas container 110 is held in place by the cap 104; or, the opening 300 may include a screw-in type mechanism, wherein the disposable gas container 110 is held in place by the threads on the disposable gas container 110 and within the opening 300. Regardless of the design of the opening 300, the spike 120 will puncture the seal of the disposable gas container 110 upon the correct insertion of the disposable gas container 110.

The opening 300 may include a one-way valve, which permits gas to enter the gas supply system 118, of FIG. 1, and a puncture type mechanism (e.g.—the spike 120) that breaks the seal on the disposable gas container 110 when a sufficient force is applied. However, it is to be understood that the type of structure (i.e.—a press fit mechanism or a screw-in type mechanism for the opening 300) used to release the contents of the disposable gas container 110 into the gas supply system 118 is not limited by the above example. In accordance with the scope of the present invention, the structure may include any system or mechanism that permits discharge of the contents of the disposable gas container 110 into the gas supply system 118 upon a sufficient force being applied to the seal of the disposable gas container 110. Furthermore, it is to be understood that the opening 300 may include a gasket, thereby creating an airtight seal that helps to prevent backflow of the discharged contents from the gas supply system 118 into the housing 102 or back into the disposable gas container 110.

Referring now to FIGS. 4 through 6. FIGS. 4 through 6 depict similar configurations as to that shown in FIGS. 1 through 3, and consequently, only the differences between the figures will be described, to avoid redundancy. Moreover, since the structure and elements of FIGS. 4 through 6 are similar to the structure and elements of FIGS. 1 through 3, identical numerals have been used and explanations thereof are occasionally omitted.

Referring now to FIG. 4, therein is shown a cross sectional view of a disposable gas system 400, in accordance with an embodiment of the present invention. The disposable gas system 400 includes a housing 102, a cap 104, a disposable gas container 110, a housing first end 112, a cap bottom side 114, a housing second end 116, a gas supply system 118, a spike 120, an orifice 122, a screw thread mechanism 402, and a groove 404. Generally, the disposable gas system 400 can be used for enhancing the performance of an internal combustion engine. More specifically, the disposable gas system 400 may dispense a gas, such as nitrous oxide, within an internal combustion engine of a car, boat, motorcycle, airplane, or other like mode of transportation employing an internal combustion engine.

Per this embodiment, the housing 102 includes a circular or oval configuration capable of holding objects within its volume. However, it is to be understood that the shape of the housing 102 is not to be limited to the above circular or oval configuration examples. In accordance with the scope of the present invention the shape of the housing 102 may include any curvilinear design or shape that has been structurally engineered to hold or contain one or more of the disposable gas container 110 within its volume.

The housing 102 can be designed to permit direct mounting to any structure or the housing 102 can be mounted to a specifically constructed bracket system including a resilient clasp system, which permits easy removal of the housing 102 from the bracket system.

By way of example, the housing 102 can be constructed from a material such as metal, plastic, or a combination thereof. Furthermore, it is to be understood that a heating element can be placed within the volume defined by the housing 102, thereby counteracting the reduced temperatures that may arise during discharge of the disposable gas container 110.

At the housing first end 112, the cap 104 is secured to the housing 102 by the screw thread mechanism 402. The screw thread mechanism 402 provides a permanent structure upon which the cap 104 can be tightened or loosened, thereby either allowing removal of the cap 104 or permitting the cap 104 to exert a force upon the disposable gas container 110. The cap 104 is structurally designed to be screwed on to the housing 102 and form a tight seal with the housing 102. In an aspect of the present embodiment, the groove 404 may be formed in the cap bottom side 114 for recessing the ends of the disposable gas container 110. The groove 404 helps to align each of the disposable gas container 110 during the act of putting on the cap 104.

Additionally, the cap bottom side 114 may include a ring shaped gasket for creating an airtight seal between the contact point of the cap 104 and the housing 102. Alternatively, the housing first end 112 may include a ring shaped gasket for creating an airtight seal between the contact point of the cap 104 and the housing 102.

Notably, the cap bottom side 114 extends into the housing 102, thereby permitting contact with the disposable gas container 110. Each of the disposable gas container 110 are mounted, connected, and/or securely coupled to the gas supply system 118 through an opening 300, of FIG. 6, formed in the housing second end 116. Per this invention, “securely coupled” is defined to mean that the disposable gas container 110 does not break its airtight seal with the opening 300 during discharge of its contents into the gas supply system 118.

The opening 300 may include a press fit mechanism, wherein the disposable gas container 110 is held in place by the cap 104; or, the opening 300 may include a screw-in type mechanism, wherein the disposable gas container 110 is held in place by the threads on the disposable gas container 110 and within the opening 300. By way of example, the opening 300 may include a one-way valve, which permits gas to enter the gas supply system 118, and a puncture type mechanism (e.g.—the spike 120) that breaks the seal on the disposable gas container 110 when a sufficient force is applied.

However, it is to be understood that the type of structure (i.e.—the opening 300) used to release the contents of the disposable gas container 110 into the gas supply system 118 is not limited by the above example. In accordance with the scope of the present invention, the structure may include any system or mechanism that permits discharge of the contents of the disposable gas container 110 into the gas supply system 118 upon a sufficient force being applied to the seal of the disposable gas container 110. Furthermore, it is to be understood that the opening 300 may include a gasket, thereby creating an airtight seal that helps to prevent backflow of the discharged contents from the gas supply system 118 into the housing 102 or back into the disposable gas container 110.

In an aspect of the present invention, the cap 104 can provide a mechanism for asserting sufficient pressure or force upon the disposable gas container 110 to discharge its contents. For example, the depth of the cap 104 that extends into the housing 102 can be structurally engineered to make contact with the disposable gas container 110, thereby permitting discharge of the contents of the disposable gas container 110 when sufficient force is applied by the cap bottom side 114 upon the disposable gas container 110.

Generally, the cap 104 can be tightened against the disposable gas container 110 by screwing the cap 104 onto the housing 102. More specifically, the cap bottom side 114 may exert a force upon the disposable gas container 110, located within the housing 102, when the cap 104 is screwed onto the housing 102 via the screw thread mechanism 402. Upon the cap bottom side 114 exerting a sufficient force against the disposable gas container 110, the disposable gas container 110 can be displaced towards the gas supply system 118 and the seal on the disposable gas container 110 can be broken against the spike 120. After the spike 120 breaks the seal of the disposable gas container 110, the contents of the disposable gas container 110 can be released into the gas supply system 118 through the opening 300.

Alternatively, in another aspect of the present embodiment, the disposable gas container 110 can be threaded or screwed into the opening 300 and the contents of the disposable gas container 110 can be discharged within the gas supply system 118 upon breaking the seal of the disposable gas container 110 upon the spike 120. Per this embodiment, the cap 104 can be designed to provide a force sufficient to merely hold the disposable gas container 110 in place after the disposable gas container 110 has been screwed into the opening 300.

The gas supply system 118 collects the discharged contents from one or more of the disposable gas container 110 and channels the discharged contents through the orifice 122. Per this embodiment, the gas supply system 118 can generally be described as a hollow structure or reservoir used for conveying or containing gas. The gas supply system 118 can be structurally engineered and designed to withstand the pressure created and/or exerted by the discharged contents of the disposable gas container 110. Moreover, the gas supply system 118 and the opening 300 are structurally engineered and designed to prevent release of its contents, except through the orifice 122.

The orifice 122 can be connected to an internal combustion engine through a conduit, such as a high-pressure hose (not shown), for example. By way of example, the conduit or hose can inject the contents of the gas supply system 118 into an air intake manifold, a cylinder head, a fuel injector, and/or a carburetor of an internal combustion engine. The methods employed and materials used for attaching/connecting a conduit (e.g.—a hose) to and between the disposable gas system 400 and an internal combustion engine are well known within the art and not repeated herein.

Uniquely, the disposable gas container 110 of the present invention is a non-refillable cylinder, cartridge, or container that can be of any size and can be replaced with another one of the disposable gas container 110 of any size. In a preferred aspect, the disposable gas container 110 may more specifically include a container that is one liter or smaller.

The present inventor has discovered that by providing the disposable gas system 400 with the disposable gas container 110 that the user of this system no longer needs to return to a gas supply retailer to recharge their empty gas containers. The user of the disposable gas system 400 is merely required to only anticipate their future need of gas and order such amount from an order distribution service. After placing an order (e.g.—by phone, internet, or mail), the requested product (i.e.—the disposable gas container 110) is shipped to the requesting party via mail, an independent delivery service, or other approved shipping method, for example.

Notably, the disposable gas container 110 may include any type of gas, which enhances the performance, output or power of an internal combustion engine. By way of example, the disposable gas container 110 may include oxygen, oxygenated liquids, kerosene, methane, ethanol, and/or a combination thereof. In a preferred aspect of the present invention, the disposable gas container 110 includes nitrous oxide.

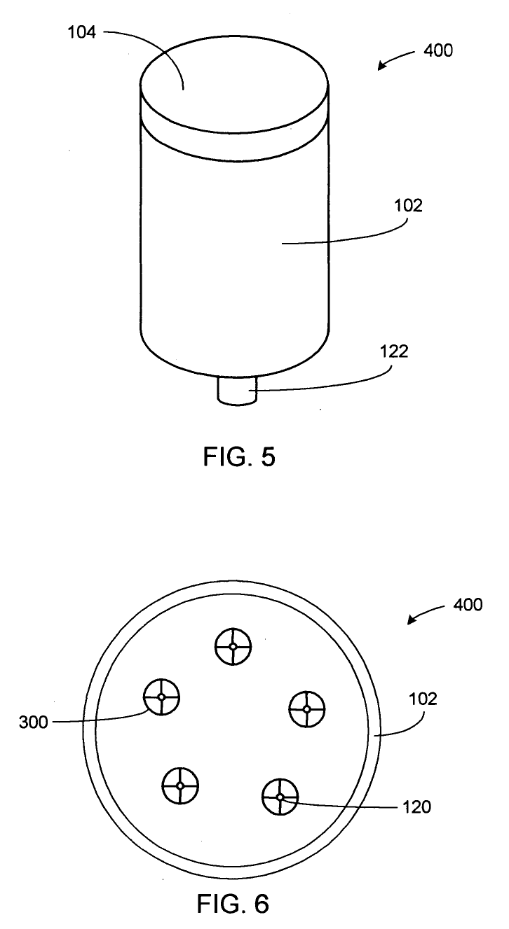

Referring now to FIG. 5, therein is shown a perspective view of the disposable gas system 400, in accordance with an embodiment of the present invention. This view depicts the housing 102, the cap 104, and the orifice 122. Although this illustration depicts the disposable gas system 400 as a cylinder shaped container, it is to be understood that the configuration of the disposable gas system 400 may include any curvilinear design or shape that has been structurally engineered to hold or contain one or more of the disposable gas container 110, of FIG. 4, within its volume.

Referring now to FIG. 6, therein is shown a top view of the disposable gas system 400 with the cap 104, of FIG. 4, removed, in accordance with an embodiment of the present invention. This view depicts the housing 102, the spike 120 and the opening 300. Per this embodiment, the opening 300 can be structurally engineered to accommodate the insertion of the disposable gas container 110, of FIG. 4.

By way of example, the opening 300 can be designed as a screw-in insertion type mechanism or the opening 300 can be designed to securely hold the disposable gas container 110 in place while the cap 104 is tightened against the disposable gas container 110. Stated another way, the opening 300 may include a press fit mechanism (sufficiently tight to hold the disposable gas container 110), wherein the disposable gas container 110 is held in place by the cap 104; or, the opening 300 may include a screw-in type mechanism, wherein the disposable gas container 110 is held in place by the threads on the disposable gas container 110 and within the opening 300. Regardless of the design of the opening 300, the spike 120 will puncture the seal of the disposable gas container 110 upon the correct insertion of the disposable gas container 110.

The opening 300 may include a one-way valve, which permits gas to enter the gas supply system 118, of FIG. 4, and a puncture type mechanism (e.g.—the spike 120) that breaks the seal on the disposable gas container 110 when a sufficient force is applied. However, it is to be understood that the type of structure (i.e.—a press fit mechanism or a screw-in type mechanism for the opening 300) used to release the contents of the disposable gas container 110 into the gas supply system 118 is not limited by the above example. In accordance with the scope of the present invention, the structure may include any system or mechanism that permits discharge of the contents of the disposable gas container 110 into the gas supply system 118 upon a sufficient force being applied to the seal of the disposable gas container 110. Furthermore, it is to be understood that the opening 300 may include a gasket, thereby creating an airtight seal that helps to prevent backflow of the discharged contents from the gas supply system 118 into the housing 102 or back into the disposable gas container 110.

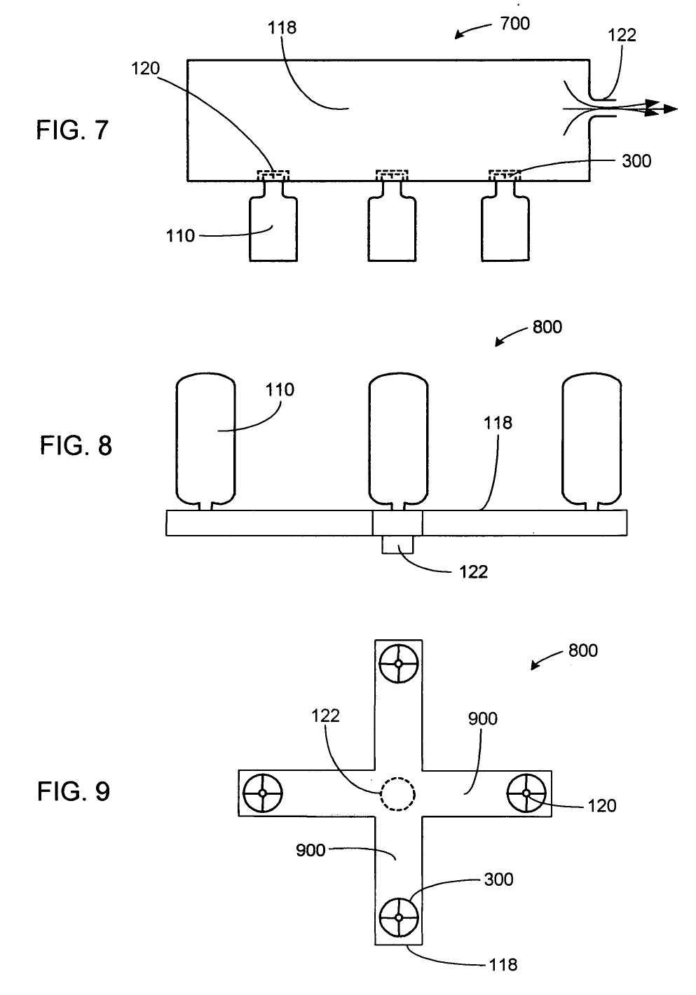

Referring now to FIG. 7, therein is shown a side view of a disposable gas system 700, in accordance with another embodiment of the present invention. The disposable gas system 700 includes the disposable gas container 110, the gas supply system 118, the spike 120 (shown in hidden outline), the orifice 122, and the opening 300 (shown in hidden outline). Per this embodiment, the disposable gas system 700 does not require the housing 102, of FIGS. 1 and 4, and the gas supply system 118 can be designed for direct mounting on a structure or the gas supply system 118 can be mounted to a specifically constructed bracket system including a resilient clasp system, which permits easy removal of the gas supply system 118 from the bracket system.

Although the present embodiment depicts three of the disposable gas container 110 connected to the gas supply system 118, it is to be understood that any number of the disposable gas container 110 can be connected to the gas supply system 118. In accordance with the scope of the present invention, the number of the disposable gas container 110 connected to the gas supply system 118 is only to be limited by the design of the gas supply system 118 (e.g.—by the number of the opening 300) and/or by the number of the disposable gas container 110 desired to be used by the user of the disposable gas system 700.

For purposes of illustration, the disposable gas container 110 can be securely coupled to the gas supply system 118 by threading or screwing-in the disposable gas container 110 into the opening 300. The opening 300 may include a one-way valve, which permits gas to enter the gas supply system 118, and a puncture type mechanism (e.g.—the spike 120) that breaks the seal on the disposable gas container 110 when a sufficient force is applied. After securely coupling the disposable gas container 110 to the gas supply system 118, the contents of each of the disposable gas container 110 can be collectively stored within the gas supply system 118 for distribution to an internal combustion engine through the orifice 122.

Per this invention, “securely coupled” and “securely coupling” are defined to mean that the disposable gas container 110 does not break its airtight seal with the opening 300 during discharge of its contents into the gas supply system 118.

Referring now to FIG. 8, therein is shown a side view of a disposable gas system 800, in accordance with another embodiment of the present invention. The disposable gas system 800 includes the disposable gas container 110, the gas supply system 118 and the orifice 122. Per this embodiment, the gas supply system 118 may include an integrally connected airtight system of one or more tubes used for conveying or containing gas discharged by the disposable gas container 110.

Referring now to FIG. 9, therein is shown a top view of the disposable gas system 800 with the disposable gas container 110, of FIG. 8, removed, in accordance with an embodiment of the present invention. The disposable gas system 800 includes the gas supply system 118, the spike 120, the orifice 122 (shown in hidden outline), the opening 300, and a hollow structure 900.

Per this embodiment, the gas supply system 118 includes an integrally connected airtight system of tubes (i.e.—the hollow structure 900) used for conveying or containing gas discharged by the disposable gas container 110. Generally, the gas supply system 118 can be described as a hub and spoke configuration, wherein the hub includes a region for coalescing the gas from each of the spoke (i.e.—the hollow structure 900). The gas exits the gas supply system 118 via the orifice 122.

The present embodiment depicts the gas supply system 118 as possessing four of the hollow structure 900. However, it is to be understood that the gas supply system 118 is not to be limited to four of the hollow structure 900. In accordance with the scope of the present invention, the gas supply system 118 may include any number of the hollow structure 900 integrally connected and designed for conveying or containing gas. Moreover, it is to be understood that the shape of the hollow structure 900 is not to be limited to a square shape. In accordance with the scope of the present invention, the shape of the hollow structure 900 may include any rectilinear or curvilinear shape, which may convey or contain gas.

The gas supply system 118 can be designed for direct mounting on a structure or the gas supply system 118 can be mounted to a specifically constructed bracket system including a resilient clasp system, which permits easy removal of the gas supply system 118 from the bracket system.

For purposes of illustration, the disposable gas container 110, of FIG. 8, can be securely coupled to the gas supply system 118 by threading or screwing-in the disposable gas container 110 into the opening 300. However, it is to be understood that the present embodiment can be readily modified to include the housing 102 and the cap 104, both of FIGS. 1 and 4; thereby, permitting discharge of the gas from the disposable gas container 110 when the cap 104 exerts a sufficient force upon the disposable gas container 110.

The opening 300 may include a one-way valve, which permits gas to enter the gas supply system 118, and a puncture type mechanism (e.g.—the spike 120) that breaks the seal on the disposable gas container 110 when a sufficient force is applied. After securely coupling the disposable gas container 110 to the gas supply system 118, the contents of each of the disposable gas container 110 can be collectively stored within the gas supply system 118 for distribution to an internal combustion engine through the orifice 122.

Per this invention, “securely coupled” and “securely coupling” are defined to mean that the disposable gas container 110 does not break its airtight seal with the opening 300 during discharge of its contents into the gas supply system 118.

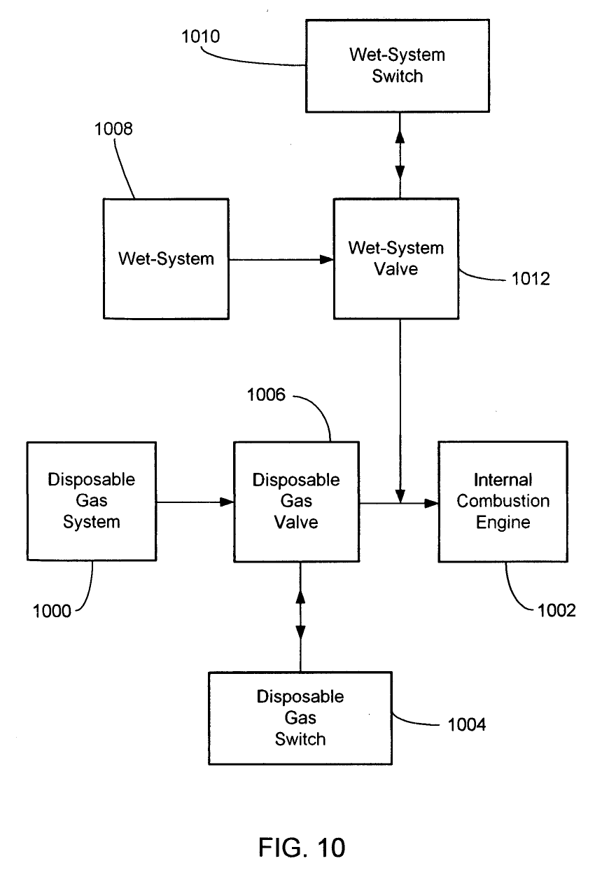

Referring now to FIG. 10, therein is shown a generalized block diagram of how a disposable gas system 1000 interfaces with an internal combustion engine 1002, in accordance with an embodiment of the present invention. It will be appreciated by those skilled in the art that many methods or systems may be employed to interconnect/interface the disposable gas system 1000 with the internal combustion engine 1002 and that the description, which follows, is provided merely for purposes of illustration.

Per this embodiment, the disposable gas system 1000 is connected to the internal combustion engine 1002 by a gas conduit (not shown), such as a high-pressure hose, for example. In an aspect of a preferred embodiment, the end of the conduit connected to the internal combustion engine 1002 may include a nozzle or jet for injecting the gas into the internal combustion engine 1002.

Notably, the flow of gas between the disposable gas system 1000 and the internal combustion engine 1002 can be controlled by a disposable gas switch 1004 operatively coupled to a disposable gas valve 1006. By way of example, the disposable gas switch 1004 may include an On/Off switch and/or a throttle switch that engages or activates the disposable gas valve 1006 when a certain user defined minimum percentage of the throttle is engaged or when a certain number of revolutions per minute of the internal combustion engine 1002 are achieved. Furthermore, by way of example, the disposable gas valve 1006 may include a solenoid valve or other type of electro-mechanical valve.

Moreover, the present invention may optionally include a wet-system 1008 controlled by a wet-system switch 1010 operatively coupled to a wet-system valve 1012 for adding additional fuel to the internal combustion engine 1002. Per this embodiment, the wet-system 1008 can be connected to the internal combustion engine 1002 by a fuel conduit (not shown), such as a high-pressure hose, for example.

In an aspect of a preferred embodiment, the fuel conduit may mix with the gas conduit before entering the internal combustion engine 1002. More specifically, by way of example, the wet-system 1008 may introduce a fuel, such as gasoline, into the gas conduit via a Y-shaped coupling that mixes the gas of the disposable gas system 1000 and the fuel of the wet-system 1008 (e.g.—by creating a fog or mist) before introduction into the internal combustion engine 1002 via a nozzle or jet.

By way of example, the wet-system switch 1010 may include an On/Off switch and/or a throttle switch that engages or activates the wet-system valve 1012 when a certain user defined minimum percentage of the throttle is engaged or when a certain number of revolutions per minute of the internal combustion engine 1002 are achieved. Furthermore, by way of example, the wet-system valve 1012 may include a solenoid valve or other type of electro-mechanical valve.

It has been discovered that the present invention thus has numerous aspects. One such aspect is that the present invention provides a disposable gas container that does not require the user to return to a gas supply retailer to recharge their empty gas containers. The user of the disposable gas container is merely required to only anticipate their future need of gas and order such amount from an order distribution service.

Another aspect of the present invention is that the user of the disposable gas system saves valuable time in procuring a performance enhancing gas for their internal combustion engine by ordering disposable gas containers from a third party provider or gas distribution service and having them delivered.

Yet another important aspect of the present invention is that it provides a simplified system that is effective, inexpensive, and efficient, thereby solving the earlier deficiencies of previous attempts within the art.

Having thus described in detail the exemplary embodiments of the invention, it is to be understood that the invention defined by the appended claims is not to be limited by the particular details and the specific language set forth in the above description and that many apparent variations thereof are possible without departing from the spirit or scope of the invention. Accordingly, the above description and accompanying drawings are only illustrative of exemplary embodiments, which can achieve the principles, concepts, features and advantages of the present invention. It is not intended that the invention be limited to the embodiments shown and described in detail herein. The invention is only limited by the scope of the following claims.

What is claimed is:

1. A disposable gas system comprising:
a reservoir including an opening and an orifice;
a disposable gas container connected to the reservoir through the opening; and
the orifice connected to an internal combustion engine.

2. The system as claimed in claim 1 wherein:
the reservoir may accommodate more than one of the disposable gas container.

3. The system as claimed in claim 1 wherein:
the disposable gas container includes a gas that enhances the performance of the internal combustion engine.

4. The system as claimed in claim 1 wherein:
the disposable gas container includes nitrous oxide.

5. The system as claimed in claim 1 wherein:
the opening includes a screw thread mechanism for securely coupling the disposable gas container.

6. A disposable gas system comprising:
a housing including an opening, a reservoir, and an orifice;
a disposable gas container within the housing connected to the reservoir through the opening; and
a cap.

7. The system as claimed in claim 6 wherein:
the housing may accommodate more than one of the disposable gas container.

8. The system as claimed in claim 6 wherein:
the cap provides a mechanism for exerting force upon the disposable gas container.

9. The system as claimed in claim 6 wherein:
the disposable gas container includes nitrous oxide.

10. The system as claimed in claim 6 further comprising:
the orifice connected to an internal combustion engine.

11. A disposable gas system comprising:
providing a reservoir including an opening and an orifice;
discharging the contents of a disposable gas container into the reservoir through the opening; and
connecting the orifice to an internal combustion engine.

12. The system as claimed in claim 11 wherein:
discharging the contents of the disposable gas container includes discharging the contents of more than one of the disposable gas container.

13. The system as claimed in claim 11 wherein:
discharging the contents of the disposable gas container includes discharging a gas that enhances the performance of the internal combustion engine.

14. The system as claimed in claim 11 wherein:
discharging the contents of the disposable gas container includes discharging nitrous oxide.

15. The system as claimed in claim 11 wherein:
discharging the contents of the disposable gas container includes securely coupling the disposable gas container to the opening.

16. The system as claimed in claim 11 wherein:
discharging the contents of the disposable gas container occurs by screwing the disposable gas container into the opening.

17. The system as claimed in claim 11 further comprising:
providing a housing and a cap for enclosing the disposable gas container.

18. The system as claimed in claim 17 wherein:
providing the housing for enclosing the disposable gas container includes enclosing more than one of the disposable gas container.

19. The system as claimed in claim 17 wherein:
providing the cap includes providing a mechanism for exerting force upon the disposable gas container.

20. The system as claimed in claim 17 wherein:
discharging the contents of the disposable gas container occurs via a force exerted by the cap.
